(19) United States
(12) Patent Application Publication
(10) Pub. No.: US 2007/0022123 A1
(43) Pub. Date: Jan. 25, 2007

(54) Methods and devices for use in transferring an electronic file

(76) Inventor: Raj Narayan Marndi, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/491,677

(22) Filed: Jul. 24, 2006

(30) Foreign Application Priority Data
Jul. 22, 2005 (IN) IN966/CHE/2005

(51) Int. Cl. G06F 17/30

(52) U.S. Cl. 707/10

(57) ABSTRACT

An embodiment of a method of facilitating a file transfer includes an initial step of receiving a first request for a first electronic file. The embodiment of the method also includes a step of determining whether the first electronic file contains a reference to a second electronic file. In addition to the two previous steps the embodiment of the method includes a step of obtaining a filename associated with the second electronic file. Furthermore, the embodiment of the method includes a step of sending the filename to a system that issued the first request.

### BACKGROUND OF THE INVENTION

Computer networks commonly employ file (or document) transfer protocols in order to allow remote computing devices to exchange electronic files (or documents) with each other. There are many file transfer protocols in existence today, each of which has been developed for a specific purpose. For example, the hypertext transfer protocol is a file transfer protocol that was developed by the Internet Engineering Task Force (IETF) and is used in the Internet to primarily support the transfer of HyperText Mark-up Language (HTML) documents.

Existing file transfer protocols have undoubtedly addressed the issue(s) that initially prompted their development. However, some existing file transfer protocols do have shortcomings. For instance, a client process using the hypertext transfer protocol can generate a significant number of file request commands (that is, the GET command) when parsing a hypertext mark-up language file that contains numerous embedded files, which is not uncommon for many of today's web pages. The hypertext transfer protocol is such that the client process will generate a separate file request command for each file embedded in the hypertext mark-up language file.

Generating the separate file request command for each file embedded in the hypertext mark-up language file is generally undesirable because it can lead to an increase in traffic on the network, which can degrade the performance of the network. Furthermore, generating separate file request commands may lead to processing delays at the web server to which the request commands were sent. The processing delays are likely to stem from having to queue the request commands at the web server.

### BRIEF DESCRIPTION OF THE DRAWINGS

Embodiments of the invention will now be described, by way of example only, with reference to the accompanying drawings in which:

FIG. 1 is a schematic diagram of a system including an embodiment of the present invention;

FIG. 2 is a flow chart of various steps performed by the system of FIG. 1 in accordance with an embodiment of the present invention;

FIG. 3 is a flow chart of more steps performed by the system of FIG. 1 in accordance with an embodiment of the present invention;

FIG. 4 is a flow chart showing the functional relationship between client and server elements of the system of FIG. 1 in accordance with an embodiment of the present invention;

FIG. 5 is an example web page used by the system of FIG. 1 in accordance with an embodiment of the present invention;

FIG. 6 is a table showing the performance of an existing file transfer protocol; and

FIG. 7 is a table showing the performance of a file transfer protocol used by the system of FIG. 1 in accordance with an embodiment of the present invention.

### DETAILED DESCRIPTION

According to an embodiment there will be described a method of facilitating a file transfer includes an initial step of receiving a first request for a first electronic file. The embodiment of the method also includes a step of determining whether the first electronic file contains a reference to a second electronic file. In addition to the two previous steps the embodiment of the method includes a step of obtaining a filename associated with the second electronic file. Furthermore, the embodiment of the method includes a step of sending the filename to a system that issued the first request.

The present technique will be more fully understood from the following description of a specific embodiment. The description is provided with reference to the accompanying drawings.

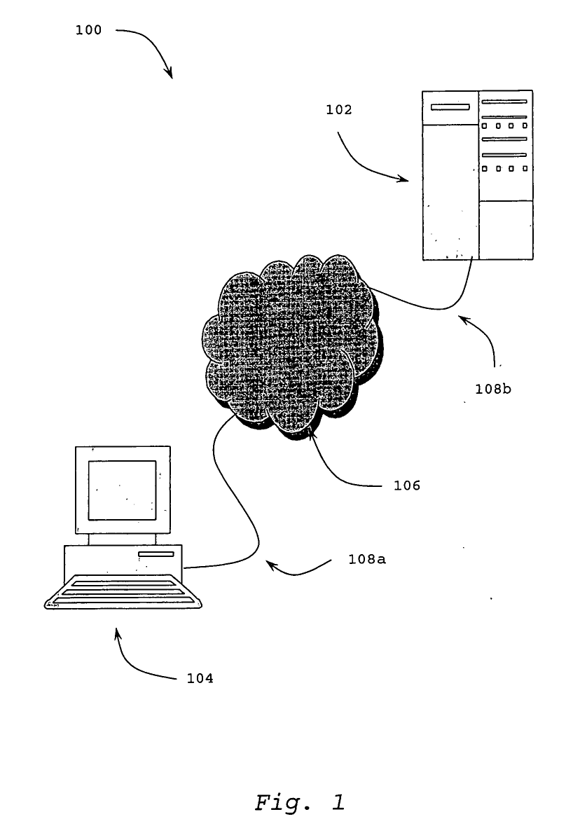

FIG. 1 is a schematic diagram of a system 100 including an embodiment. The system 100 includes a computer server 102, a personal computer 104 and a communication network 106.

The computer server 102 is in the form of an Internet web server and as such includes traditional computer hardware such as a motherboard, central processing unit, random access memory, one or more hard disks, a network card, and a power supply. In addition to the computer hardware, the computer server 102 includes a Unix based operating system (such as, for example, HP-UX). The operating system resides on the hard disk of the computer server 102. It is envisaged that in alternative embodiments of the technique disclosed here the computer server 102 need not be with the Unix based operating system and can employ, for example, the Microsoft Server 2003 operating system.

The operating system and the hardware of the computer server 102 cooperate with each to provide an environment in which software applications can be executed. In this regard, the hard disk of the computer server 102 is loaded with a web server application (such as, for example, Apache) that enables the computer server 102 to function as an Internet based web server. In addition to the web server application, the hard disk of the computer server 102 is also loaded with a software application that aims to improve the efficiency of serving web pages from the computer server 102. Further details on how the software application aims to improve the efficiency of serving web pages is provided in subsequent paragraphs of this specification.

The personal computer 104 is in the form of a desk top computer. However, it is envisaged that in alternative embodiments of the present disclosure the personal computer 104 can be in the form of, for example, a laptop computer or a blackberry device, for instance. The personal computer 104 includes traditional hardware such as a motherboard, central processing unit, random access memory, one or more hard disks, a network card, a power supply, a keyboard, a monitor, and a mouse. In addition to the hardware, the personal computer 104 includes the Microsoft XP operating system. The Microsoft XP operating system is loaded on the hard disk of the personal computer 104. The technique being described here is not restricted to using the Microsoft XP operating system on the personal computer 104. Consequently, in alternative embodiments of the technique disclosed the hard disk of the personal computer 104 can be loaded with, for example, the Linux operating system.

The Microsoft XP operating system and the hardware of the personal computer 104 cooperate with each other to provide an environment in which software applications can be executed. In this regard, the hard disk of the personal computer 104 is loaded with the Microsoft Internet Explorer web browser for enabling a user of the personal computer 104 to log on to web servers, including the computer server 102. The technique disclosed here is not restricted to being used with the Microsoft Internet Explorer web browser. As such an alternative embodiment of the present technique can employ, for example, the Firefox browser. In addition to the Internet Explorer web browser, the hard disk of the personal computer 104 is loaded with a software application that aims to improve the efficiency of obtaining web pages from the computer server 102. Further details on how the software application aims to improve the efficiency of obtaining web pages is provided in subsequent paragraphs of this specification.

The communication network 106 is in the form of the Internet and as such includes many interconnected packet routers/switches. Each packet router/switch supports an Internet Protocol (IP) routing protocol (for example, Open Shortest Path First, OSPF) for allowing packets of data to be exchanged between devices connected to the communication network 106. In this regard, it is noted that both the computer server 102 and the personal computer 104 are both connected to the communication network 106 via data links 108. In the present embodiment of the technique the data link 108a connecting the personal computer 104 to the communication network 106 is in the form of xDSL technology. In an alternative embodiment, the link 108a between the personal computer 104 and the communication network 106 can be, for example, a traditional dial-up modem link. The link 108b connecting the computer server 102 to the communication network 106 is in the form of ISDN link. However, alternative embodiments of the technique disclosed need not use an ISDN link and can, for example, use xDSL. As described in more detail in the subsequent paragraphs, the communication network 106 basically allows the computer server 102 and the personal computer 104 to exchange web pages.

While the communication network 106 has been described as being in the form of the Internet, it is noted that the present technique is not restricted to the Internet. Alternative embodiments of the technique disclosed here can employ different networks such as, for example, an IP based intranet.

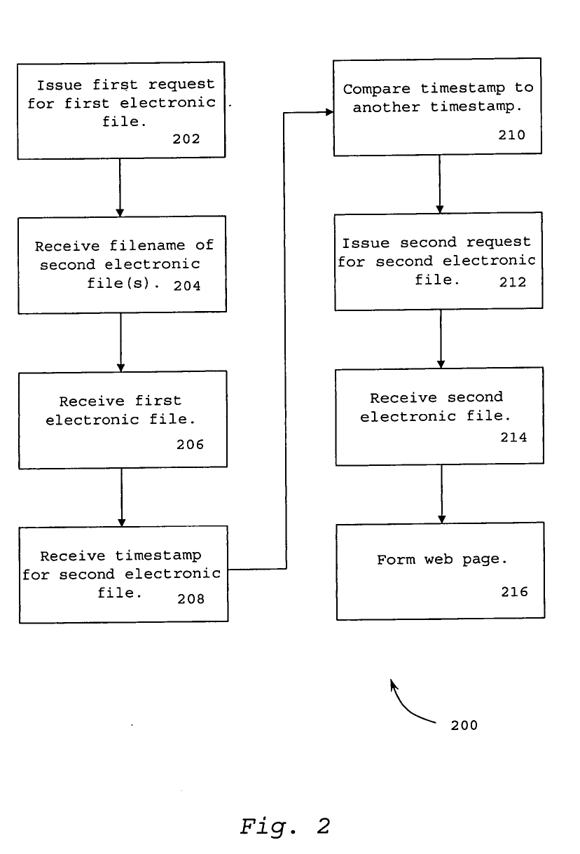

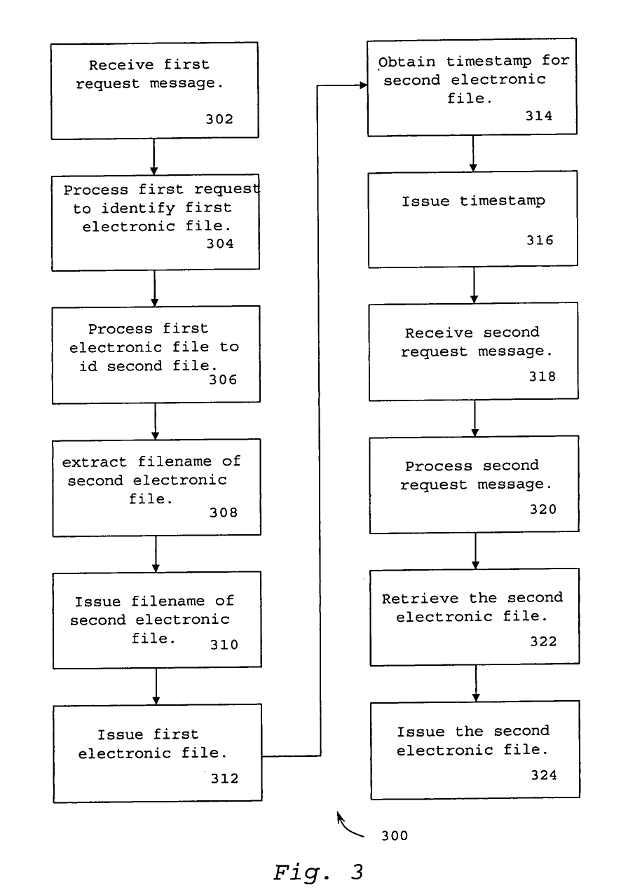

As indicated previously, both the computer server 102 and the personal computer 104 include a software application that aims to improve the efficiency of exchanging web pages. In this regard, the various steps performed by the software application loaded on the personal computer 104 are set out in the flow chart 200 of FIG. 2, while the steps performed by the software application loaded on the computer server 102 are set out in the flow chart 300 of FIG. 3.

With reference to FIG. 2, the initial step 202 performed by the software application loaded on the personal computer 104 is to issue the computer server 102 with a first request message for a first electronic file. In this embodiment of the present technique the first electronic file is a hypertext mark-up language document. It is envisaged that the first electronic file can be in a format other than the hypertext mark-up language such as, for example, the extensible mark-up language (XML).

To issue the computer server 102 with the first request message, the software application loaded on the personal computer 104 provides the first request message to the communication network 106 using the network hardware and software of the personal computer 104. On receiving the first request message the communication network 106 transfers the message to the computer server 102. The first request message is in the form of a hypertext transfer protocol GET request message. If for instance the filename of the first electronic file is index.html, the first request message would, for example, be of the form GET /hypertext/www/index.html, where /hypertext/www represents the directory (file system location) of the index.html file.

The software application loaded on the personal computer 104 can be caused to carry out the initial step 202 of issuing the first request message by several means. For instance, when the user of the personal computer 104 clicks on a hyperlink of a web page displayed by the Internet Explorer browser. Alternatively, by typing a uniform resource locator (URL), such as http://www.computer.server.com/index.html, directly in to the Internet Explorer browser.

As described in the subsequent paragraphs of this specification, the response of the computer server 102 to receiving the first request message is to issue the filename of one or more second electronic files that are embedded in the first electronic file. The second electronic files can be different files and can, for example, include image files, video files, sound files or hypertext mark-up language files. In addition to issuing the filenames of the second electronic files, the computer server 102 also issues the first electronic file (which was identified in the first request message). Consequently, the second step 204 performed by the software application on the personal computer 104 is to receive the filenames of the one or more second electronic files embedded in the first electronic file. In addition to the second step 204 the software application performs the third step 206 of receiving the first electronic file. To perform the second step 204 and the third step 206 the software application loaded on the personal computer 104 interacts (using the network hardware and software loaded on the personal computer 104) with the communication network 106 to receive the filenames of the one or more second electronic files and the first electronic file. The filename of the one or more second electronic files and the first electronic file are issued by the computer server 102 in the form of a hypertext transfer protocol response message.

Another action that the computer server 102 performs in response to receiving the first request message is to issue (as a hypertext transfer protocol response message) a timestamp that has been allocated to each of the one or more second electronic files. The actions performed by the computer server 102 in relation to the timestamp are described in more detail in the subsequent paragraphs of this specification. The timestamps represents the last time and/or the date the respective second electronic file was modified; that is, had data written thereto. Each timestamp is automatically assigned by the operating system of the computer server 102 each time a write operation is performed on the second electronic file. Given that the computer server 102 issues the timestamps, another step 208 performed by the software application loaded on the personal computer 104 is to receive the timestamps from the computer server 102. To receive the timestamps the software application uses the network hardware and software of the personal computer 104 to receive the timestamp via the communication network 106.

On receiving the timestamp, the software application loaded on the personal computer 104 performs the step 210 of comparing each timestamp to another timestamp associated with a version of the related second electronic file that resides on the personal computer 104. More specifically, the step 210 of comparing the timestamps involves first determining whether there is a cached version of the second electronic file stored locally on the personal computer 104. Assuming the personal computer 104 has a locally cached version of the second electronic file, the software application compares the two timestamps to determine which of the two second electronic files is the most up-to-date. If the timestamp associated with the locally cached version of the second electronic file is later than the timestamp received during the previous step 208, the software application loaded on the personal computer 104 assumes that is has the most up-to-date version of the second electronic file stored locally in its cache and proceeds to perform the final step 216 of forming a webpage (which is described in more detail in subsequent paragraphs of this specification).

If, however, the timestamp of the locally cached version of the second electronic file is earlier than the timestamp received during the previous step 208, the software application loaded on the personal computer 104 assumes that the locally cached version of the second electronic file is out-of-date and that a more up-to-date version can be obtained from the computer server 102. On assuming that the locally cached second electronic file is out-of-date, the software application loaded on the personal computer 104 proceeds to perform the step 212 of providing the computer server 102 with a second request message for the second electronic file. It is noted that the step 212 of providing the computer server 102 with the second request is also performed in the event that as a result of performing the previous step 210 it is determined there is no cached version of the second electronic file.

As with the first request message, the software application loaded on the personal computer 104 provides the second request message to the communication network 106 by using the network hardware and software of the personal computer 104. On receiving the second request message the communication network 106 transfers the message to the computer server 102. In the event that there exists a plurality of the second electronic files the step 212 of providing the second request message involves sending a single second request message that identifies the plurality of second electronic files. Thus, sending a single second request message is likely to generate less network traffic than the existing hypertext transfer protocol, which will generate a separate request message for each second electronic file. The second request message is in the form of a hypertext transfer protocol GET request message which includes a specific header indicating that the GET request message a GET message used by the traditional hypertext transfer protocol.

As discussed in more detail in the subsequent paragraphs of this specification, the computer server 102 responds to being provided with the second request message my issuing the one or more second electronic files identified in the second request message. Consequently, the software application loaded on the personal computer 104 performs the step 214 of receiving the second electronic file. To receive the second electronic file the software application uses the network hardware and software of the personal computer 104 to receive the second electronic file via the communication network 106.

Once the software application loaded on the personal computer 104 has received the second electronic file it proceeds to perform the final step 216 of forming a web page to be displayed in the Internet Explorer browser by embedding the second electronic file in to the first electronic file. For example, if the second electronic file was a JPG image the final step 216 would involve embedding the JPG image in to the first electronic file. The web page formed as a result of the final step 216 would then be presented to the user of the personal computer 104 by means of the Internet Explorer web browser.

As described previously, the computer server 103 is loaded with a software application that performs the various steps of the flow chart 300 in FIG. 3. The first 302 of these steps involves receiving the first request message, which was issued by the personal computer 104 during a previous step 202. To receive the first request message the software application loaded in the computer server 102 uses the network hardware and software of the server 102 to receive the first request message from the communication network 106. After receiving the first request message the software application proceeds to perform the step 304 of processing the first request message to identify the first electronic file requested by the personal computer 104.

Once the software application loaded on the computer server 102 has identified the first electronic file the application proceeds to carry out the step 306 of processing the first electronic file to determine whether the first electronic file contains a reference, in the form of a uniform resource locator, to the second electronic file(s). More specifically, when processing the first electronic file the step 306 involves parsing the first electronic file to identify any uniform resource locators. On identifying a uniform resource locator the software application loaded on the computer server 102 proceeds to perform the step 308 of obtaining (extracting) a filename of the second electronic file from the uniform resource locator.

Once the software application loaded on the computer server 102 has performed the previous step 308, the software application proceeds to carry out the step 310 of sending the filename (which was obtained during the previous step 308) to the personal computer 104. This is effectively the step that the computer server 102 performs to allow the personal computer 104 to perform the previous step 204 of receiving the filenames. The software application is also arranged to perform the step 312 of sending the first electronic file to the personal computer 104, which enables the personal computer 104 to perform the previous step 206 of receiving the first electronic file. The software application loaded on the computer server 102 is arranged to obtain the first electronic file from the local file system of the computer server 102.

The previous two steps 310 and 312 involving sending the filename and the first electronic file as hypertext transfer protocol responses. In relation to sending the filename, the software application is arranged to send multiple filenames in a single response when there are a plurality of second electronic files. In order to send the filename and the first electronic file the software application loaded on the computer server 102 uses the network hardware and software to have the filename and the first electronic file transferred to the personal computer 104 via the communication network 106.

The software application loaded on the computer server 102 also performs the step 314 of obtaining a timestamp that is associated with the second electronic file and the step 316 of sending the timestamp to the personal computer 104. As discussed previously, the computer server 102 basically performs the previous two steps 314 and 316 to allow the personal computer 104 to determine whether it has the most up-to-date version of the second electronic file stored locally in a cache. When performing the step 314 of obtaining the timestamp the software application checks the file system, which maintains the timestamp attribute. Furthermore, in the event there are a plurality of second electronic files embedded (referred) to in the first electronic file, the step 314 of obtaining the timestamp will involve obtaining multiple timestamps, while the step 316 of sending the timestamp involves sending multiple timestamps (one for each second electronic file). To keep network traffic to a minimum the multiple timestamps are sent in a single response message. To carry out the step 316 of sending the timestamp to the personal computer 104 the software application uses the network hardware and software to have the timestamp transferred to the personal computer 104 via the communication network 106.

As outlined previously, the software application loaded on the personal computer 104 performs the step 212 of providing the computer server 102 with a second request message (in the form of a hypertext transfer protocol request message) for the second electronic file. Consequently, the software application loaded on the computer server 102 performs the step 318 of receiving the second request message which contains the filename of one or more second electronic files. The step 318 of receiving the second request message includes using the network hardware and software to receive the second message via the communication network 106.

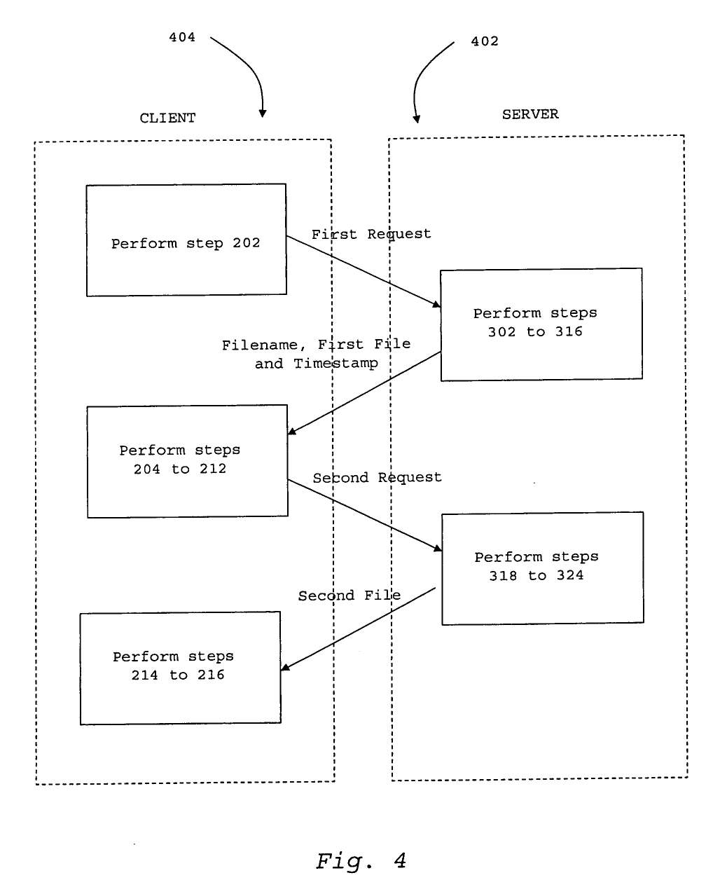

After receiving the second request message the software application performs the step 320 of processing the second request message to obtain the filename (identify) of the one or more second electronic files. Using the filename the software application loaded on the server computer 102 performs the step 322 of retrieving the second electronic file from the local file system of the computer server 102. The last step 324 that the software application performs is to send the second electronic file (which was retrieved during the previous step 322) to the personal computer 104. To send the second electronic file to the personal computer 104 the software application uses the network hardware and software to have the second electronic file transferred via the communication network 106. The relationship of the various steps 202 to 216 performed by the personal computer 404 and the steps 302 to 324 performed by the computer server 402 are shown in FIG. 4.

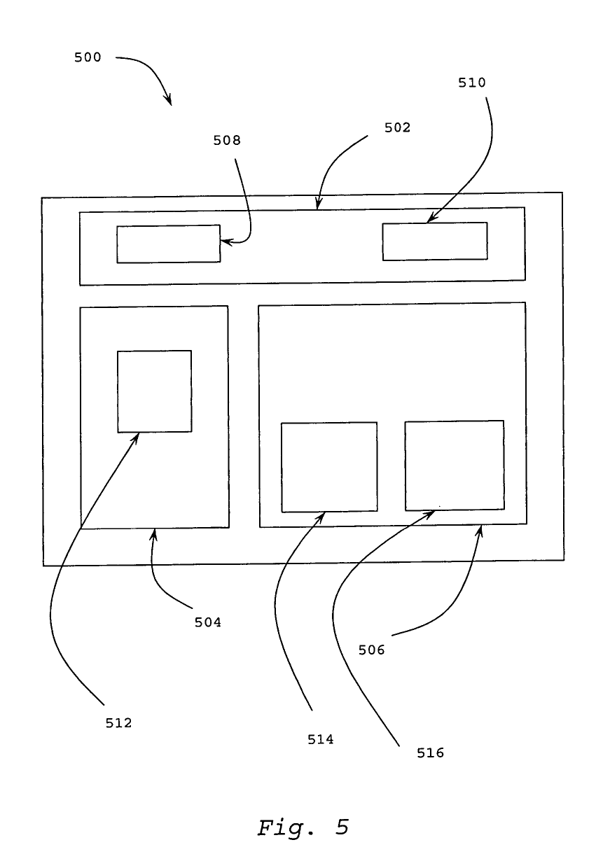

As indicated previously, the software applications loaded on the computer server 102 and the personal computer 104 aim to improve the efficiency of obtaining web pages. As an example of how the software application can improve the efficiency, consider the web page 500 illustrated in FIG. 5. With reference to the previous description of the embodiment of the present technique, the web page 500 is maintained in the first electronic file. The web page includes three frames 502, 504 and 506. The first frame 502 includes two elements 508 and 510 that are contained in independent embedded files. The second frame 504 includes one element 512 that is contained in an independent embedded file, while the third frame 506 has two elements 514 and 516. Each of the elements in the frames 502, 504 and 506 can be, for example, images, video clips or sound clips. The independent embedded files containing the various elements 508 to 516 are the second electronic files referred to previously.

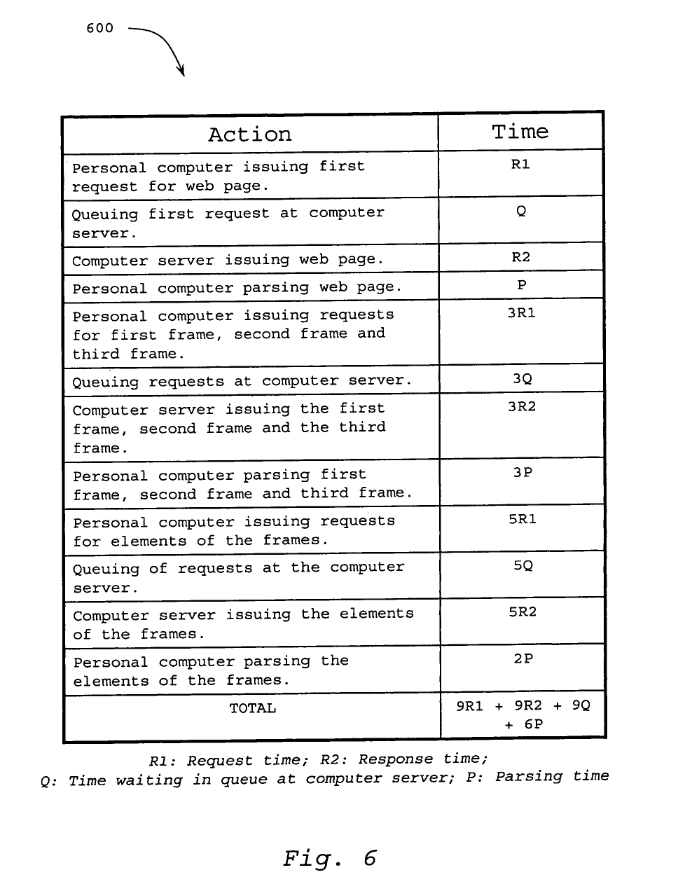

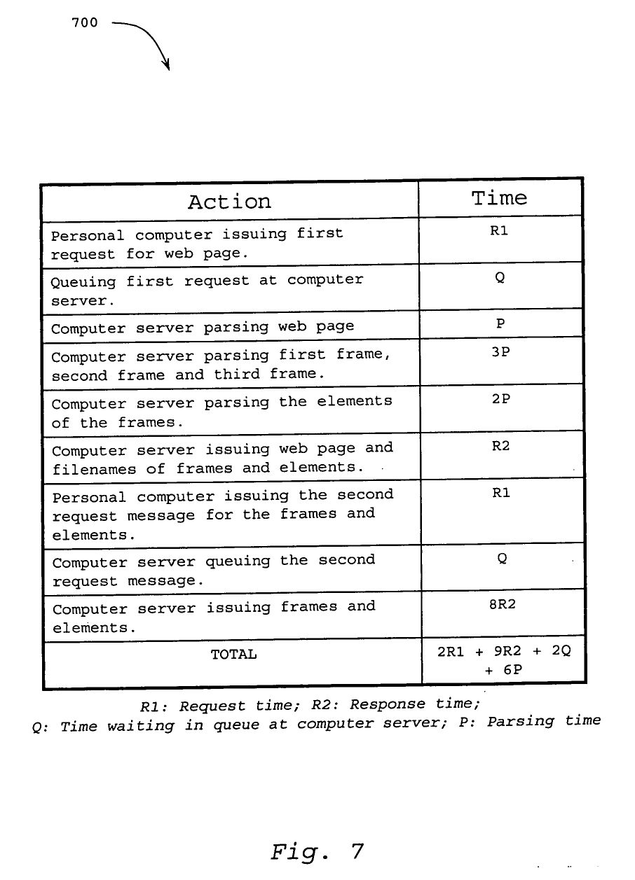

Using the existing hypertext transfer protocol, the performance associated with transferring the web page 500 from the computer server 102 to the personal computer 104 is set out in the table 600 of FIG. 6. In contrast, however, the performance associated with using the embodiment of the technique disclosed to transfer the web page 500 from the computer server 102 to the personal computer 104 is set out in the table 700 of FIG. 7. The improved performance offered by the embodiment of the disclosed technique basically stems from the fact the embodiment employs server side parsing. The existing hypertext transfer protocol uses client side parsing. Furthermore, the improvement in performance is the result of the fact that the present technique sends a single request for multiple second electronic files (the elements 508 to 516). The existing hypertext transfer protocol would, however, send multiple requests each being for one of the elements 508 to 516.

An embodiment of a device for facilitating a file transfer includes a processing means arranged to perform an initial step of receiving a first request for a first electronic file. After performing the initial step the processing means is arranged to perform the step of determining whether the first electronic file contains a reference to a second electronic file. In addition to the previous to steps the processing means is arranged to perform the step of obtaining a filename associated with the second electronic file. Furthermore, the processing means is arranged to perform the step of sending the filename to a system that issued the first request.

An embodiment of a method of facilitating a file transfer includes an initial step of issuing a first request for a first electronic file. The method also includes the step of receiving a filename of a second electronic file to which the first electronic file contains a reference.

An embodiment of a device for facilitating a file transfer includes a processing means arranged to perform an initial step of issuing a first request for a first electronic file. The processing means also performs the step of receiving a filename of a second electronic file to which the first electronic file contains a reference.

For the sake of clarity and simplicity, the embodiment of the present technique has been described in the context of identifying ‘first level’ embedded files; that is, the step 306 of identifying embedded files has been described as not going beyond looking for the one or more second electronic files embedded in the first electronic file. It is, however, envisaged that the process of identifying embedded files be a recursive process and not one that is restricted to identifying first level embedded files. Consequently, the step 306 of identifying embedded file is considered to include processing of the second electronic files to identify any additional files that may be embedded therein, processing the additional files to identify any files embedded therein and so on.

Any of the steps of the embodiment that are related to the second electronic files also relate to any embedded files that go beyond first level embedded files. For example the step 314 of obtaining the timestamp is also performed for embedded files beyond the first level.

While the present technique has been described with reference to the preferred embodiment, it will be understood by those skilled in the art that alterations, changes and improvements may be made and equivalents may be substituted for the elements thereof and steps thereof without departing from the scope of the present disclosure. In addition, many modifications may be made to adapt to a particular situation or material to the teachings of the technique disclosed without departing from the central scope thereof. Such alterations, changes, modifications and improvements, though not expressly described above, are nevertheless intended and implied to be within the scope and spirit of the disclosure. Therefore, it is intended that the technique disclosed here not be limited to the particular embodiments disclosed as the best mode contemplated for carrying out this technique, but that the technique will include all embodiments falling within the scope of the independent claims.

What is claimed is:

1. A method of facilitating a file transfer, the method comprising the steps of:
receiving a first request for a first electronic file;
determining whether the first electronic file contains a reference to a second electronic file;
obtaining a filename associated with the second electronic file; and
sending the filename to a system that issued the first request.

2. The method as claimed in claim 1, further comprising the steps of:
obtaining a timestamp associated with the second electronic file; and
sending the timestamp to the system.

3. The method as claimed in claim 2, further comprising the steps of:
receiving a second request for the second electronic file; and
sending the second electronic file to the system in response to receiving the second request.

4. The method as claimed in claim 3, further comprising the step of sending the first electronic file to the system.

5. The method as claimed in claim 1, wherein the step of determining whether the first electronic file contains the reference comprises using at least one of the following steps:
parsing the first electronic file to identify the reference; and
determining whether an electronic record contains the filename.

6. The method as claimed in claim 4, wherein the steps of receiving the first request, receiving the second request, sending the filename, sending the timestamp, sending the first electronic file and sending the second electronic file each comprise the step of interacting with a communication network to respectively receive the first request, receive the second request, send the filename, send the timestamp, send the first electronic file and send the second electronic file.

7. The method as claimed in claim 6, wherein the communication network comprises an internet protocol packet switched network.

8. The method as claimed in claim 3, wherein the first request and the second request each conform to a hypertext transfer protocol request.

9. A device for facilitating a file transfer, the device comprising a processing means arranged to perform the steps of:
receiving a first request for a first electronic file;
determining whether the first electronic file contains a reference to a second electronic file;
obtaining a filename associated with the second electronic file; and
sending the filename to a system that issued the first request.

10. The device as claimed in claim 9, wherein the processing means is further arranged to perform the steps of:
obtaining a timestamp associated with the second electronic file; and
sending the timestamp to the system.

11. The device as claimed in claim 10, wherein the processing means is further arranged to perform the steps of:
receiving a second request for the second electronic file; and
sending the second electronic file to the system in response to receiving the second request.

12. The device as claimed in claim 11, wherein the processing means is further arranged to perform the step of sending the first electronic file to the system.

13. The device as claimed in claim 9, wherein the processing means is arranged such that the step of determining whether the first electronic file contains the reference comprises using at least one of the following steps:
parsing the first electronic file to identify the reference; and
determining whether an electronic record contains the filename.

14. The device as claimed in claim 12, wherein the processing means is arranged such that the steps of receiving the first request, receiving the second request, sending the filename, sending the timestamp, sending the first electronic file and sending the second electronic file each comprise the step of interacting with a communication network to respectively receive the first request, receive the second request, send the filename, send the timestamp, send the first electronic file and send the second electronic file.

15. The device as claimed in claim 11, wherein the first request and the second request each conform to a hypertext transfer protocol request.

16. A method of facilitating a file transfer as claimed in claim 1, wherein the method comprising the steps of:
issuing a first request for a first electronic file; and
receiving a filename of a second electronic file to which the first electronic file contains a reference.

17. The method as claimed in claim 16, further comprising the steps of:
receiving a timestamp;
comparing the timestamp to another timestamp associated with a version of the second electronic file; and
issuing a second request for the second electronic file if a result of comparing the timestamp to the other timestamp meets a criterion.

18. A device for facilitating a file transfer as claimed in claim 10, the device comprising a processing means arranged to perform the steps of:
issuing a first request for a first electronic file; and
receiving a filename of a second electronic file to which the first electronic file contains a reference.

19. The device as claimed in claim 18, wherein the processing means is further arranged to perform the steps of:
receiving the first electronic file; and
receiving the second electronic file.

20. A computer program comprising at least one instruction arranged to cause a computing device to perform the steps of:
receiving a first request for a first electronic file;
determining whether the first electronic file contains a reference to a second electronic file;
obtaining a filename associated with the second electronic file; and
sending the filename to a system that issued the first request.
